(19) United States
(12) Patent Application Publication
(10) Pub. No.: US 2006/0119119 A1
(43) Pub. Date: Jun. 8, 2006

(54) Mobile-pole lifter for moving ferromagnetic loads

(76) Inventor: Danilo Molteni, Manerbio BS (IT)

Correspondence Address: LUCAS & MERCANTI, LLP, 475 PARK AVENUE SOUTH, 15TH FLOOR, NEW YORK, NY, 10016, US

(21) Appl. No.: 10/524,005

(22) PCT Filed: Aug. 8, 2002
(86) PCT No.: PCT/IT02/00530

§ 371 Date: Oct. 14, 2005

(51) Int. Cl. B66C 1/04

(52) U.S. Cl. 294/65.5

(57) ABSTRACT

A magnetic lifter includes at least one dipolar mobile pole (1) consisting of two ferromagnetic pole pieces (2, 3), joined through an elastic connection, and inserted between two fixed opposite polarities (5, 6) of an electromagnet (7) so as to be able to slide within a housing (8) formed therebetween. By using as mobile poles (1) dipoles which slide between two poles (5, 6) of opposite polarity the closure of the magnetic circuit occurs within the single mobile pole (1) whereby the contact losses are reduced to half and it is possible to lift even small- and medium-sized loads with the greatest ease. Moreover, thanks to the elastic connection between the two pole pieces (2, 3) which allows a change in their mutual distance, upon activation of the lifter the two pole pieces (2, 3) tend to move away from each other until they adhere through magnetic attraction each one to its own adjacent polarity, thus canceling the air gaps and the consequent leaks as well as the risks of sliding.

The present invention relates to magnetic lifters used to move ferromagnetic loads, and in particular to a mobile-pole lifter of new design.

It is known that existing mobile-pole lifters (electromagnets, electropermanent or permanent magnets) are mainly used to lift loads of ferromagnetic steel with an uneven contact surface such as rows of billets, round bars, tubes, etc. These mobile poles are intended to partially make up for the differences in height between the single elements of the load thus increasing the performance of the lifters, but to date they have always been inserted each one as a monopole in the seat of a pole to act as a sliding pole piece. In other words, even in lifters provided with one or more rows of mobile poles each of them is just an extension of a South pole or of a North pole.

However, these known lifters have a series of drawbacks stemming from this structure which can be summarized in the following points:
a) in order to allow the sliding of the mobile poles there are provided structural air gaps between the latter and the fixed poles, however these air gaps get wider in time due to the wear caused by the sliding friction between the two parts (e.g. from the initial 0.5 mm to 2 mm and more), and this leads to a significant magnetic leak with consequent decrease of the lifting capacity;
b) also due to the air gaps, known lifters produce the maximum lift only when the mobile poles are completely extracted, i.e. in the only position where the mechanical restraint preventing their further extraction prevents them from sliding under load;
c) since the mobile poles are monopoles, they have to lead the flux lines of the magnetic field from the pole in which they are inserted, passing through the load, to an adjacent pole of opposite polarity (as all poles are only North or only South), which results in doubling the contact losses;
d) for the same reason, with known lifters it is almost impossible to lift loads of small or medium size since it is not possible to short-circuit the two polarities North and South on a single element in a suitable and effective way.

Therefore the object of the present invention is to provide a magnetic lifter which is free from said drawbacks. This object is achieved by means of a magnetic lifter wherein the mobile poles are dipoles sliding between two poles of opposite polarities, each mobile pole consisting of two elastically connected pole pieces. Other advantageous features of the present lifter are disclosed in the subsequent claims.

A first main advantage of the present lifter stems from the fact that by using as mobile poles dipoles which slide between two poles of opposite polarity the closure of the magnetic circuit occurs within the single mobile pole. This results in the contact losses being reduced to half and in the possibility of lifting even small- and medium-sized loads with the greatest ease.

A second significant advantage results from the elastic connection between the two pole pieces acting as poles of the mobile dipole, since thanks to such elasticity their mutual distance can change. In other words, upon activation of the lifter the two pole pieces tend to move away from each other until they adhere through magnetic attraction each one to its own adjacent polarity, thus canceling the air gaps and the consequent leaks as well as the risks of sliding.

Further advantages and characteristics of the lifter according to the present invention will be clear to those skilled in the art from the following detailed description of some embodiments thereof, with reference to the annexed drawings wherein:

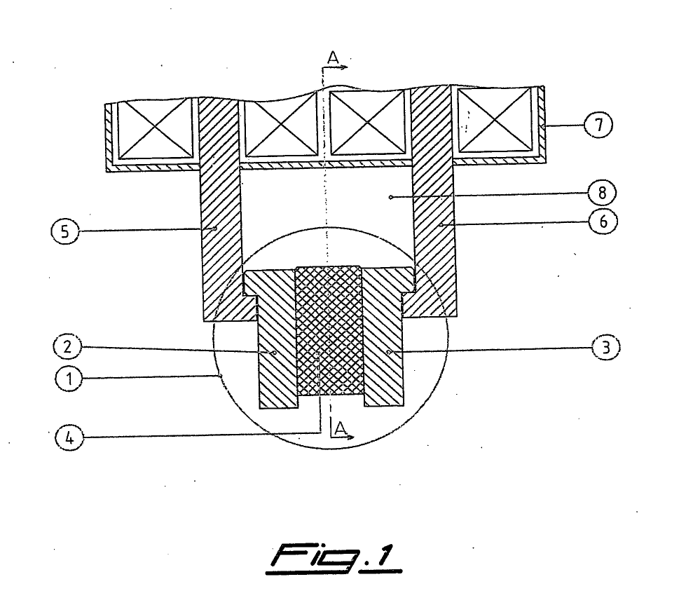

FIG. 1 is a diagrammatic front view in vertical section of a first embodiment of a lifter according to the invention;

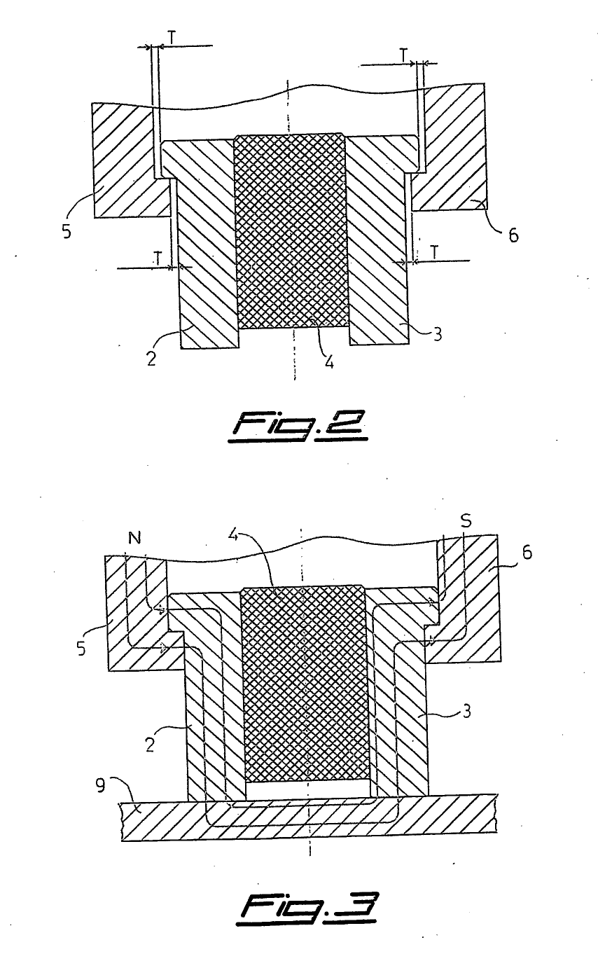

FIG. 2 is a view similar to the preceding one which shows an enlarged detail of the mobile pole at rest, i.e. when the lifter is not active;

FIG. 3 is a view similar to the preceding one which shows the mobile pole in a load engagement state, i.e. when the lifter is active;

FIGS. 4 and 5 are diagrammatic side views in vertical section taken along line A-A of FIG. 1 which show two variations of said first embodiment; and

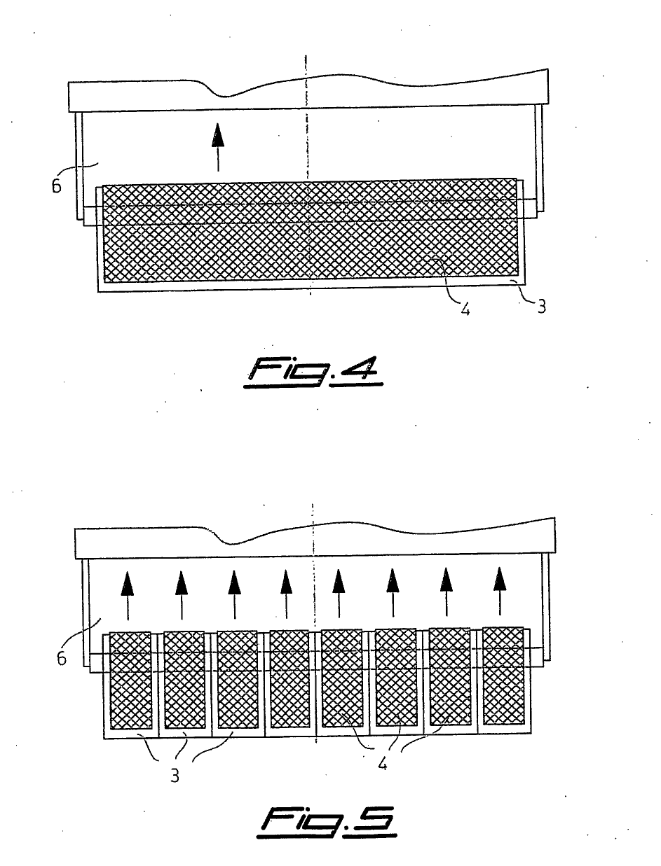

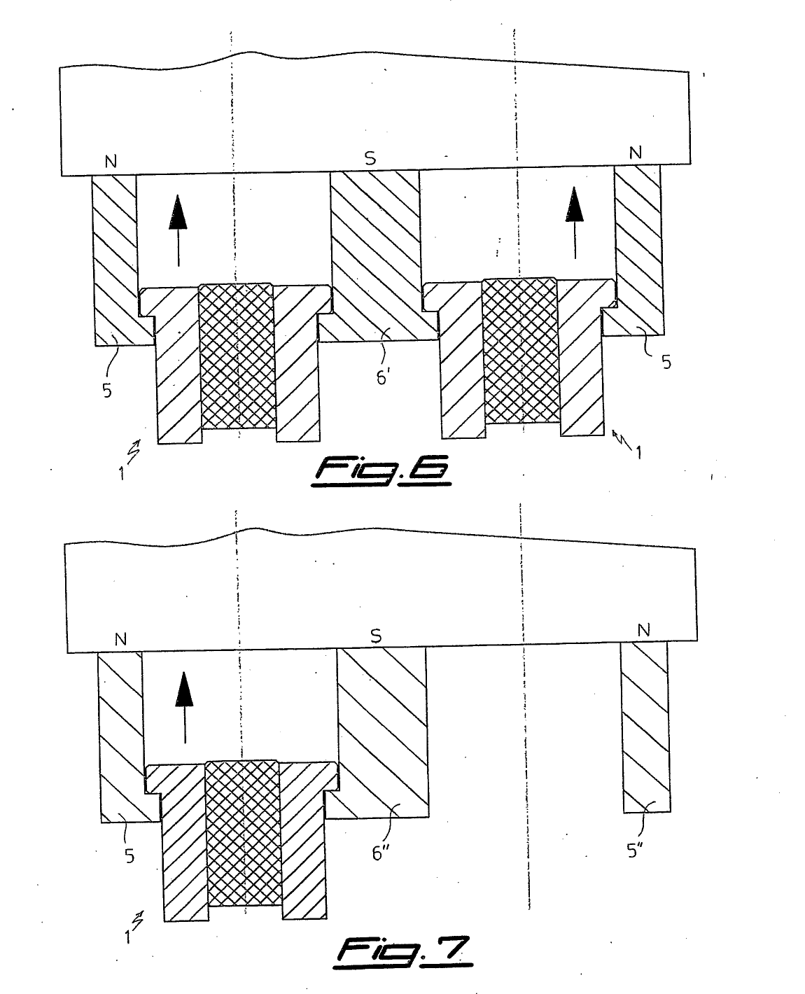

FIGS. 6 and 7 are diagrammatic front views in vertical section which show other two variations in number and arrangement of the poles.

Referring first to FIGS. 1-3, there is seen that the novel aspect of the lifter according to the present invention is that of including a dipolar mobile pole 1 made up of two ferromagnetic pole pieces 2, 3 joined through an elastic connection consisting of an elastomer 4. Said mobile pole 1 is inserted between two opposite polarities 5, 6 of an electromagnet 7 so as to be able to slide within a suitable housing 8 formed therebetween, with the two pole pieces 2, 3 respectively adjacent to a North polarity and a South polarity.

The shape of pole pieces 2, 3 and of polarities 5, 6 is conventional and allows to prevent the slipping out of the mobile pole 1, and it provides an air gap T which in time may significantly increase in width due to wear.

The operation of the present lifter is very simple and effective and is readily understood: the mobile pole 1 gets in contact with the ferromagnetic load 9 to be lifted and, upon activation of the electromagnet 7, the two pole pieces 2, 3 tend to move away from each other until they adhere through magnetic attraction each one to its own adjacent polarity 5, 6 by dilating elastomer 4 as required, so that they too become a North polarity and a South polarity and substantially cancel the structural air gaps T and the consequent leaks.

At this moment each dipole is put in the condition of being able to effectively lift a single load with a minimum contact loss and no sliding problems, even if pole 1 is partially retracted, since there is a direct magnetic lock on the North and South polarities of the lifter.

Elastomer 4 is designed to have an elasticity suitable for the lifter power, so as to allow a complete cancellation of the air gaps T during operation while maintaining the capacity of moving near again the pole pieces 2, 3 even after many operating cycles to guarantee a smooth sliding of the mobile pole 1. For example vulcanized rubber with a Shore hardness in the range of 50-60 may be used, to which the pole pieces 2, 3 are secured by gluing or through fastening means (e.g. bolts).

A further advantage of said mobile poles 1 coming from the presence of elastomer 4 is their capacity of absorbing possible bumps even to a significant extent without damages.

The longitudinal sectional views of FIGS. 4 and 5 illustrate how the lifter may include a single long mobile pole or a row of independent mobile poles which are however enclosed between only two fixed poles 5, 6. Obviously there is also provided the arrangement, similar to the conventional one, of a series of mobile poles sliding between as many pairs of fixed poles.

The frontal sectional views of FIGS. 6 and 7 illustrate how the lifter may include two (rows of) mobile poles 1 side to side which share a fixed “two-faced” central pole 6′, or a single pole (or row of poles) 1 combined with a further fixed pole 5″ which operates in cooperation with a central fixed pole 6″ of greater width.

It is clear that the above-described and illustrated embodiments of the lifter according to the invention are just examples susceptible of various modifications. In particular, the elastic connection between the pole pieces 2 and 3 could be achieved by any other material which in addition to make physically integral the dipole allows for the necessary operating elasticity; such as clothes of various fabrics, sheet of nonmagnetic material, coil springs, etc.

Moreover it is obvious that the above-illustrated different possible variations as to number, shape and arrangement of the mobile and fixed poles and as to the type of lifter (electromagnet, electropermanent or permanent magnet) can be freely combined thus leading to a great design flexibility with the capacity of adapting to multiple operating requirements.

1-6. (canceled)

7. A magnetic lifter characterized in that it includes at least one dipolar mobile pole consisting of two ferromagnetic pole pieces joined through an elastic connection and inserted between two fixed opposite poles so as to be able to slide within a housing formed between said two fixed opposite poles.

8. A magnetic lifter according to claim 1, wherein the elastic connection consists of an elastomer.

9. A magnetic lifter according to claim 2, wherein the elastic connection is made of vulcanized rubber with a Shore hardness in the range from 50 to 60.

10. A magnetic lifter according to claim 1, characterized in that it includes a plurality of independent dipolar mobile poles aligned and enclosed between only two fixed opposite poles.

11. A magnetic lifter according to claim 4, wherein the elastic connection of the dipolar mobile poles consists of an elastomer.

12. A magnetic lifter according to claim 5, wherein said elastic connection is made of vulcanized rubber with a Shore hardness in the range from 50 to 60.

13. A magnetic lifter according to claim 1, characterized in that it includes at least two dipolar mobile poles arranged one to the side of the other which share a central two-faced fixed pole.

14. A magnetic lifter according to claim 7, wherein the elastic connection of the dipolar mobile poles consists of an elastomer.

15. A magnetic lifter according to claim 8, wherein said elastic connection is made of vulcanized rubber with a Shore hardness in the range from 50 to 60.

16. A magnetic lifter according to claim 1, characterized in that it includes at least one further fixed pole which operates in cooperation with one of the two fixed opposite poles that act as sliding guide for one or more dipolar mobile poles.

17. A magnetic lifter according to claim 10, wherein said fixed pole which operates in cooperation with said further fixed pole has a greater width than the other of the two fixed opposite poles that act as sliding guide.
